(19) United States
(12) Patent Application Publication
(10) Pub. No.: US 2002/0029934 A1
(43) Pub. Date: Mar. 14, 2002

(54) LIFTING DEVICE

(76) Inventor: DAVID S GRADZIUK, STAFFORDSHIRE (GB)

Correspondence Address: GROOVER & ASSOCIATES PC, 17000 PRESTON ROAD SUITE 230, DALLAS, TX, 75248

(21) Appl. No.: 09/443,930

(22) Filed: Nov. 19, 1999

Related U.S. Application Data
(63) Continuation of application No. PCT/GB99/00870, filed on Mar. 19, 1999.
(63) Continuation of application No. PCT/WO99/48799, filed on Mar. 19, 1999.

(30) Foreign Application Priority Data
Mar. 20, 1998 (GB) 9805891.0

(51) Int. Cl. B66F 7/28

(52) U.S. Cl. 187/216; 187/214; 187/217; 187/218; 187/219

(57) ABSTRACT

A lifting device, for use in connection with a motor-cycle or similar vehicle, comprises a generally H-shaped base (10) mounted upon a support-beam (14) associated with a lifting-column (15) and lifting-beam (16). The lifting-beam (16) supports a lifting-assembly of generally T-shape, comprising a first beam (22) and a second beam (23). The beam (22) is of hollow rectangular section and adapted to receive front and rear mountings to support a motor-cycle or similar vehicle. A first set of mountings (24, 25) is adapted to support a motor-cycle beneath its chassis, while a second set of mountings (26, 27) is adapted to support a motor-cycle beneath its tires or wheels. The device includes a bracket-and-clamp assembly (18, 19, 20) to receive and support the vehicle's own side stand.

This invention relates to a lifting device and particularly (though not exclusively) to a lifting device for use in connection with a motor-cycle or similar vehicle.

The present invention therefore provides a lifting device comprising a base-member adapted in use to support the device on a substantially level surface, a support-beam extending laterally from the base-member, a lifting-column attached to the distal end of the support-beam and extending substantially perpendicularly upwardly therefrom, together with a lifting-assembly in operative engagement with the lifting-column, the lifting-assembly being adapted to be raised and lowered along the axis of the lifting-column.

Suitably, the base-member is of substantially “H”-shaped configuration. Preferably, the centre-rail of the “H” is of larger overall dimension than the side-rails of the “H”.

Preferably, the lifting-assembly comprises a first beam extending substantially at 90° from the lifting column and in a plane substantially parallel to that of the base member, together with a second beam attached to the distal end of the first beam and extending substantially at 90° on either side of the first beam, the second beam also being in a plane substantially parallel to that of the base member.

The second beam of the lifting-assembly is suitably adapted, in use, to support beneath its engine area a vehicle to be lifted by means of a device according to the present invention.

For example, means may be provided which are adapted, in use, to engage and support the wheels and/or tires of a motor-cycle or similar vehicle.

Alternatively, means may be provided which are adapted, in use, to engage the rear suspension of a motor-cycle or similar vehicle and to support the vehicle from beneath the engine area.

Again alternatively, means may be provided which are adapted, in use, to engage the rear swing-arm and front forks of a motor-cycle or similar vehicle.

In a particularly preferred embodiment of the present invention, means are provided to engage and support the side-stand of a motor-cycle or similar vehicle. Such means may, for example, include a bracket-and-clamp assembly. The foot of the vehicle's own side-stand engages the bracket and is secured thereto by means of, say, a C-bolt and associated cap-screw. Preferably, the bracket-and-clamp assembly is pivotally attached to the lifting-means (for example, to the support-beam associated with the lifting-column) and is capable of being moved through 360° about its point of attachment.

Preferably, with reference to the lifting-assembly, the beam adapted, in use, to support the vehicle may be of hollow construction and adapted to receive one or more sets of mountings on which the vehicle is supported. For instance, mountings can be provided which support the vehicle at points beneath its chassis. Alternatively, mountings can be provided which support the vehicle at the base of the wheels or tires.

In a further embodiment of the present invention, the mountings are adapted for longitudinal and/or lateral movement relative to the beam.

In a yet further embodiment, the beam which is adapted, in use, to support the vehicle is provided with beam brackets, each bracket extending at substantially 90° to the longitudinal axis of the beam and being adapted, in use, to support vehicles such as custom vehicles, off-road bicycles or tricycles and four-wheeled “all-terrain” vehicles. One or more of the brackets may be provided with additional means (such as hook-bolts or the like) for further securing the vehicle before lifting. Again, each bracket can be adapted for movement relative to the beam.

The lifting-assembly may suitably be raised and lowered on the lifting-column by means of a threaded shaft (e.g. a trapezoidal screw-shaft) in association with a lifting nut acting on the lifting-beam. The shaft may be rotated by means of a drive-nut or the like. Rotation of the drive-nut can be achieved by mechanical means such as a crank-handle. Alternatively, the drive-nut can be rotated by means of a motor. Locking means such as a security-bolt may be provided to engage the lifting-beam so that the device can be locked in the raised position for added security.

In addition, provision can be made for adjusting the angle of the lifting-column relative to the ground or other surface, to compensate for any unevenness in the surface on which the lifting-device is to stand.

Thus, the present invention provides a secure, stable and versatile lifting device which is capable of lifting vehicles, especially motor-cycles and the like, to facilitate maintenance and repair work. The device according to the present invention can be readily portable and can be used on any relatively firm surface.

The present invention will be illustrated, merely by way of example, in the following description and with reference to the accompanying drawings.

In the drawings (wherein like numerals denote like parts):

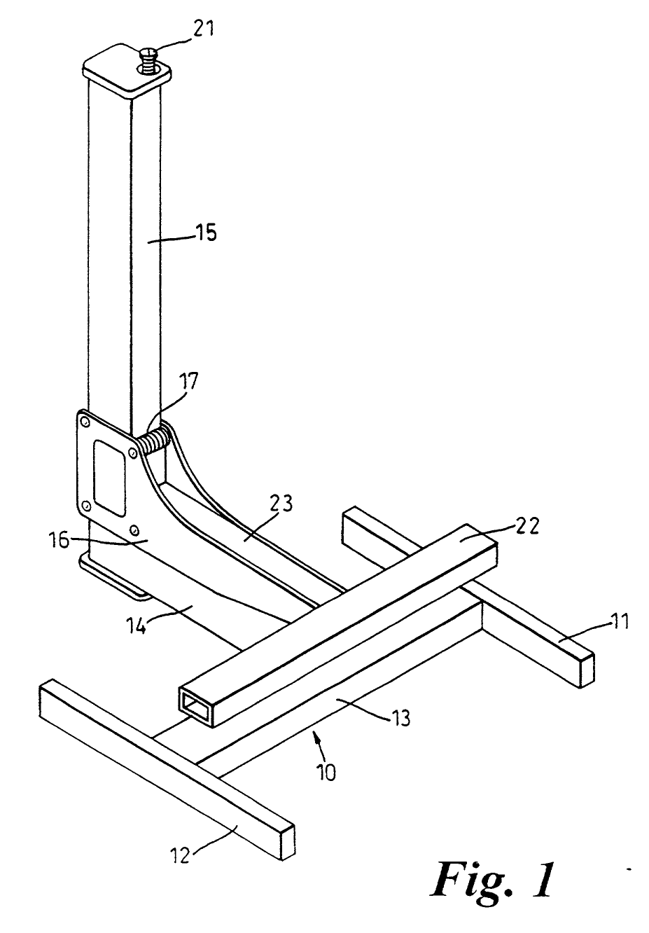

FIG. 1 is a perspective view of a lifting device according to the present invention;

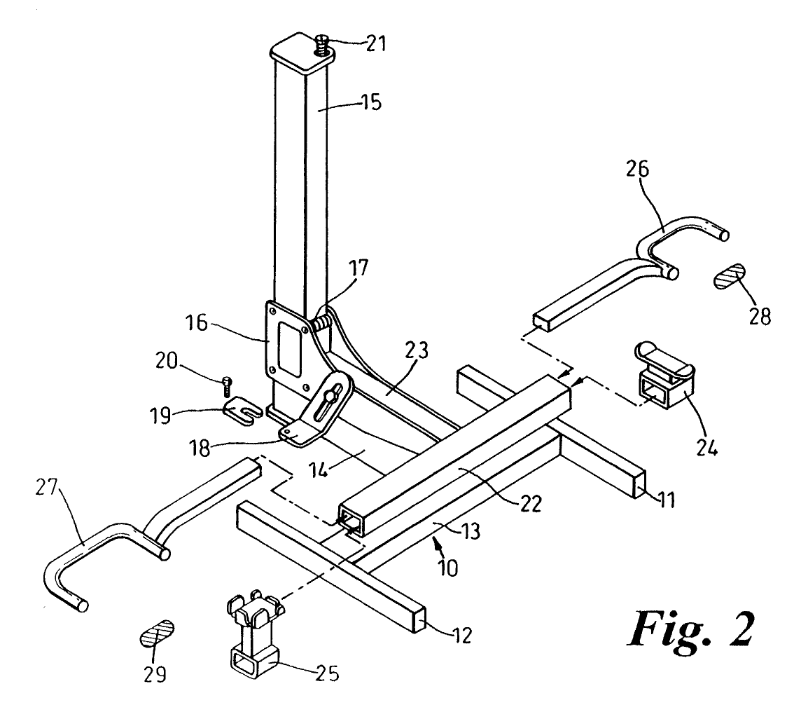

FIG. 2 shows the device of FIG. 1, including two alternative support means for a motor cycle or similar vehicle;

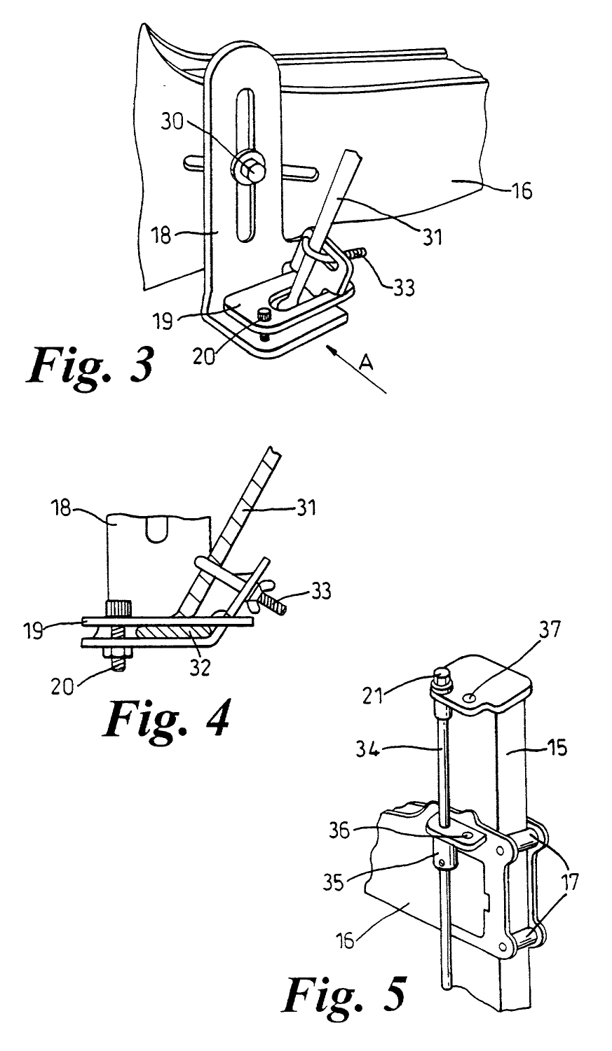

FIG. 3 is an enlarged perspective view of the support for a cycle side-stand shown in FIG. 2;

FIG. 4 is a view in the direction of arrow A in FIG. 3;

FIG. 5 is a part view of the lifting means of the device shown in FIGS. 1 and 2;

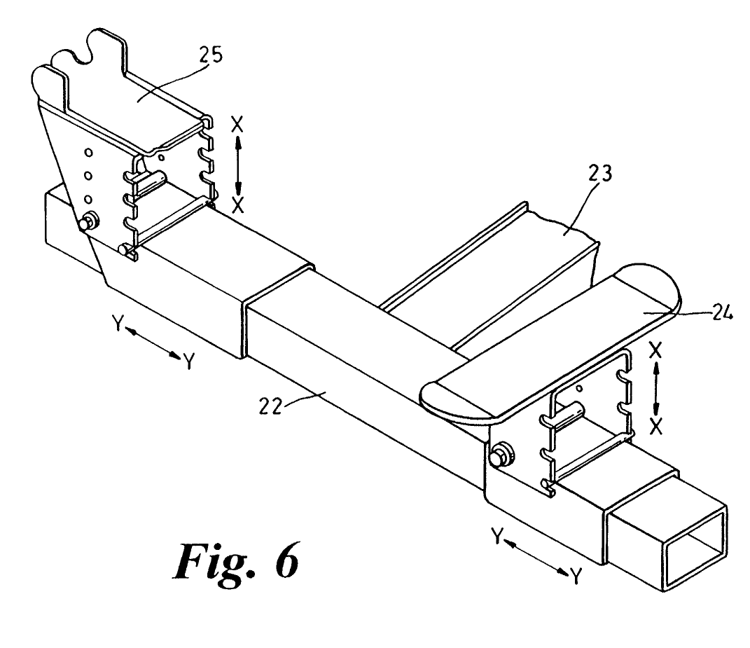

FIG. 6 is a perspective view of a further support means to be used in connection with the device shown in FIGS. 1 and 2;

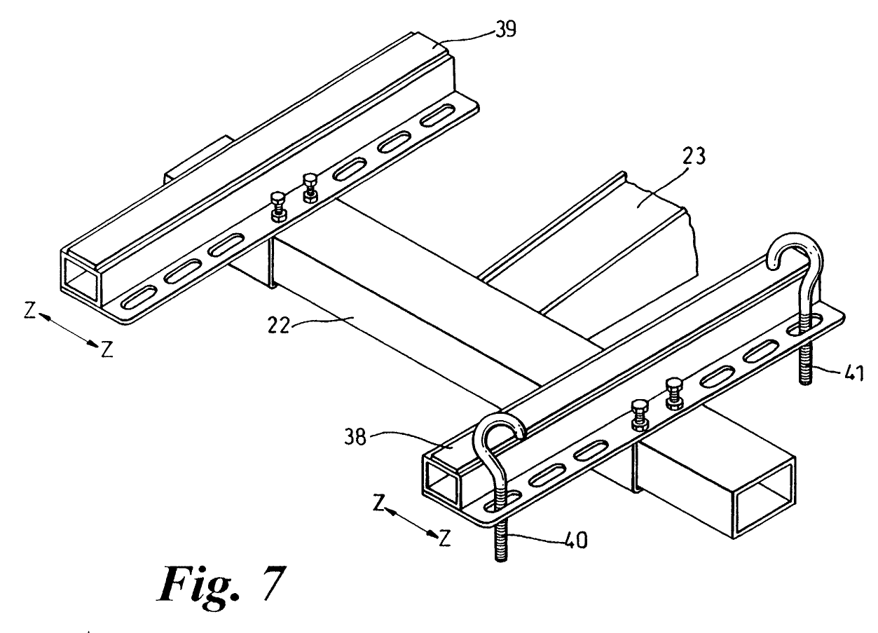

FIG. 7 is a perspective view of yet a further support means to be used in connection with the device shown in FIGS. 1 and 2.

Referring to FIGS. 1 and 2, a lifting device according to the present invention comprises a generally H-shaped base 10 having side-rails 11 and 12 and a centre-rail 13. Preferably, the centre-rail 13 is of larger overall dimension than the side-rails 11 and 12.

The base 10 is supported on a support-beam 14 which extends at 90° from the centre of rail 13. The support-beam is attached, at its end remote from the base 10, to a vertical lifting-column 15 operatively associated with a lifting-beam 16. The lifting-beam is provided with rollers 17 (only one shown) to maintain contact with the lifting-beam 15 and to provide stability when the device is in use. A bracket 18 adapted, in use, to support a motor-cycle under its side-stand, is attached to the lifting-beam 16 and is provided with securing means comprising a C-clamp 19 and cap-screw 20 (see FIG. 2). Means operable by way of a drive-nut 21 are provided to raise and lower the lifting-beam 16 on the lifting-column 15.

A generally T-shaped lifting assembly, which in use supports the weight of a vehicle to be lifted, comprises a first beam 22 and a second beam 23, the second beam 23 being attached to and supported on the lifting-beam 16.

The beam 22 is of hollow rectangular section and is adapted to receive front and rear mountings, 24 and 25 respectively, whereby a vehicle to be lifted can be supported under its chassis. Alternatively, mountings 26 and 27 can be received in beam 22, these mountings being adapted in use to support a vehicle to be lifted at the base of its wheels or tires. The general location of the wheels or tires is shown in FIG. 2 by “footprints” 28 and 29.

Referring to FIGS. 3 and 4, the bracket 18, attached by means of adjuster-bolt 30 to the lifting-beam 16, supports a motor-cycle or similar vehicle under the vehicle's own side-stand 31. The foot 32 of the side-stand is supported on bracket 18 and is secured against movement by means of C-clamp 19 and associated cap-screw 20, as well as by means of hook-bolt 33.

With reference to FIG. 5, the lifting-beam 16 is raised and lowered on the column 15 by means of a screw-shaft 34 acting on lifting-nut 35, the screw-shaft being rotated by rotation of the drive-nut 21. Drive-nut 21 can be rotated manually (e.g. by means of a crank-handle or the like). Alternatively, drive-nut 21 can be rotated by means of a motor. Locking means (for example a security-bolt) may be provided to secure the device in a raised position, the locking means being adapted to engage the lifting-beam through bolt-holes 36 and 37.

In FIG. 6, there is shown a further embodiment of the lifting device of the present invention, wherein mountings 24 and 25 are adapted for movement relative to the beam 22, as shown by arrows XX and YY.

In a still further embodiment, shown in FIG. 7, of the lifting device of the present invention, the beam 22 is provided with beam-brackets 38 and 39, by means of which custom vehicles, off-road bicycles or tricycles and four-wheeled “all-terrain” vehicles can be lifted. Bracket 38 is provided with additional hook-bolts 40 and 41 for further securing the vehicle before lifting. The brackets 38 and 39 are adapted for movement relative to the beam 22, as shown by arrows ZZ.

1. A lifting device comprising a base member, adapted in use to support the device on a substantially level surface, a support beam extending laterally from the base member, a lifting column attached to the distal end of the support beam and extending substantially perpendicularly upwardly therefrom, together with a lifting assembly in operative engagement with the lifting column, the lifting assembly being adapted to be raised and lowered along the axis of the lifting column.

2. A device according to claim 1, in which the base member is of substantially “H”-shaped configuration.

3. A device according to claim 2, in which the central rail of the “H” is of larger overall dimension than the side rails of the “H”.

4. A device according to claim 1, 2 or 3, in which the lifting assembly comprises a first beam extending substantially at 90° from the lifting column and in a plane substantially parallel to that of the base member, together with a second beam attached to the distal end of the first beam and extending substantially at 90° on either side of the first beam, the second beam also being in a plane substantially parallel to that of the base member.

5. A device according to any one of the preceding claims, adapted for use in connection with a motor-cycle or similar vehicle, in which the second beam of the lifting assembly is adapted to support the vehicle beneath its engine area.

6. A device according to claim 5, in which the lifting assembly further comprises means adapted in use to engage the wheels and/or tires of the motor cycle or similar vehicle.

7. A device according to claim 5, in which the lifting assembly further comprises means adapted in use to engage the rear suspension of the motor cycle or similar vehicle.

8. A device according to claim 5, in which the lifting assembly further comprises means adapted in use to engage the rear swing-arm and front forks of the motor cycle or similar vehicle.

9. A device according to any one of claims 5 to 8, in which the lifting assembly further comprises means adapted in use to engage the side-stand of the motor cycle or similar vehicle.

10. A device according to claim 9, in which the means adapted to engage the side-stand comprises a bracket-and-clamp assembly operatively associated with the lifting assembly.

11. A device according to claim 10, in which the bracket-and-clamp assembly is pivotally attached to the lifting assembly and is capable of being moved through 360° about the attachment point.

12. A device according to any one of the preceding claims, in which the lifting assembly includes a threaded shaft operatively associated with the lifting column, whereby rotation of the threaded shaft about its longitudinal axis results in upward or downward movement of the lifting assembly relative to the lifting column.

13. A device according to claim 12, in which the threaded shaft is adapted to be rotated manually.

14. A device according to claim 12, in which the threaded shaft is adapted to be rotated by means of a motor.

15. A lifting device, substantially as hereinbefore described, with reference to and as illustrated in the accompanying drawings.
